(19) United States
(12) Patent Application Publication
(10) Pub. No.: US 2009/0056142 A1
(43) Pub. Date: Mar. 5, 2009

(54) Powered safety razor systems

(76) Inventors: Terence Gordon Royle, Hampshire (GB); Ian James Saker, Berkshire (GB)

Correspondence Address: THE PROCTER & GAMBLE COMPANY;Global Legal Department - IP, Sycamore Building - 4th Floor, 299 East Sixth Street, CINCINNATI, OH, 45202, US

(21) Appl. No.: 11/665,235

(22) PCT Filed: Oct. 7, 2005
(86) PCT No.: PCT/EP05/10836

§ 371 Date: Nov. 10, 2008

(30) Foreign Application Priority Data
Oct. 18, 2004 (GB) 0423099.1

(51) Int. Cl. B26B 19/12; B26B 19/28

(52) U.S. Cl. 30/43.7; 30/42

(57) ABSTRACT

As shaving system comprises a shaving head structure; a blade frame defining a longitudinal axis; and at least two blades mounted in the blade frame, each having a cutting edge extending parallel to the longitudinal axis. The frame is mounted on said structure for oscillatory motion perpendicular to, or about an axis parallel to, said longitudinal axis; and a drive system coupled to said frame produces said oscillatory motion. The amplitude of said oscillatory motion is chosen to exceed 0.4 mm and the frequency exceeds 80 Hz go give an average cutting speed greater than 400 mm per second. In one embodiment at least one blade faces in each of two opposed shaving directions, and the amplitude of said oscillatory motion exceeds the spacing between the cutting edges of said oppositely facing blades. The spacing is preferably in the range 0.6 to 1.4 mm and said amplitude is preferably in the range 0.4 to 2.0 mm.

### FIELD OF THE INVENTION

The present invention relates to powered shaving systems.

### BACKGROUND OF THE INVENTION

With few exceptions, powered shaving systems have previously fallen into one of two categories: a system of the foil and undercutter type in which the undercutter is oscillated relative to the foil; and systems having a rigid guard covering a rotary sharp undercutter. Systems in which an exposed razor sharp blade is brought into contact with the skin (usually with the application of a lubricant) have largely remained unpowered, although there are exceptions.

EP-A-1 201 375 describes a wet shaving device having a pair of vibrating blades mounted in a so-called “slide shoe”. The blades are caused to vibrate longitudinally of their cutting edges by means of an electrically driven vibrator.

Another proposal can be seen from U.S. Pat. No. 6,421,918 to Dato et al. A shaving system comprises a pair of razor blades mounted in tandem in a razor head and a mechanism for vibrating the blades at a frequency in the range from 15 kilohertz to 2 megahertz. Vibrating the blades in this way is alleged to enhance cutting efficiency. The amplitude of vibration of the head together with the blades is in the range of 10 to 100 microns.

WO 2004/018165 (Zuidervaart et al.) describes a powered shaving device having two parallel razor blades which are driven in a periodical elliptical motion at a frequency in the range 100 to 1000 Hz, preferably 200 Hz. The major axis of the ellipse has a length 0.1 to 0.6 mm and the minor axis a length 0.02 to 0.15 mm, i.e. the amplitude of motion along the major axis is in the range 0.05 to 0.3 mm, which is probably inadequate to shave efficiently.

WO 04/018166 (Teeuw et al.) describes a special coating for wet shaving blades, which coating is stated to be particularly suitable for reciprocating or vibrating driven blades to reduce cutting forces.

Conventional or wet shaving systems are known having multiple blades intended to take advantage of the so-called “hysteresis effect”. However, during normal shaving the time interval between the engagement of respective blades with a given hair tends to be too long to prevent the hair retracting before the second blade engages the hair.

### DESCRIPTION OF THE INVENTION

An object of the invention is to provide a powered shaving system in which cutting efficiency is improved.

According to one aspect of the invention, there is provided a shaving system comprising: a shaving head structure; a blade frame defining a longitudinal axis; at least two blades mounted in the blade frame, each having a cutting edge extending parallel to the longitudinal axis; said frame mounted on said structure for oscillatory motion perpendicular to said longitudinal axis; and a drive system coupled to said frame to produce said oscillatory motion, wherein the amplitude of said oscillatory motion is at least 0.4 mm and the frequency of said oscillatory motion is at least 80 Hz. Preferably the amplitude of said oscillatory motion is chosen in the range 0.4 to 2.0 mm and the frequency of said oscillatory motion is chosen in the range 80 to 300 Hz.

Preferably a first of said blades and a second of said blades are oriented to perform shaving in opposed shaving directions.

According to another aspect of the invention, there is provided a method of shaving in which a blade frame carrying at least two spaced blades is caused to perform linear motion over the face and the blade frame is caused to oscillate in the direction of said linear motion with an amplitude of at least 0.4 mm and a frequency of at least 80 Hz.

Preferably, said amplitude is in the range 0.4 to 2.0 mm and said frequency is in the range 80 to 300 Hz. Said amplitude may be about 1.2 mm and said frequency about 120 Hz.

### BRIEF DESCRIPTION OF THE DRAWINGS

For a better understanding of the invention, and to show how the same may be carried into effect, reference will now be made by way of example, to the accompanying drawings, in which:

FIG. 1 shows a perspective view of the working parts of a powered shaving system according to a first embodiment of the invention;

FIG. 2 shows an exploded view of the assembly of FIG. 1;

FIG. 3 shows a perspective view of the working parts of a powered shaving system according to a second embodiment of the invention;

FIG. 4 shows an exploded view of the assembly of FIG. 3;

FIGS. 5, 6 and 7 show oscillatory motion of a main chassis from below at various stages of rotation;

FIGS. 8, 9, 10 and 11 show various possible blade arrangements;

FIG. 12 shows a perspective view of the working parts of a powered shaving system according to a third embodiment of the invention;

FIG. 13 shows an exploded view of the assembly of FIG. 12;

FIG. 14 shows a side view of the assembly of FIG. 12; and

FIG. 15 shows the direction of motion of part of the assembly of FIG. 14.

### DESCRIPTION OF PREFERRED EMBODIMENTS OF THE INVENTION

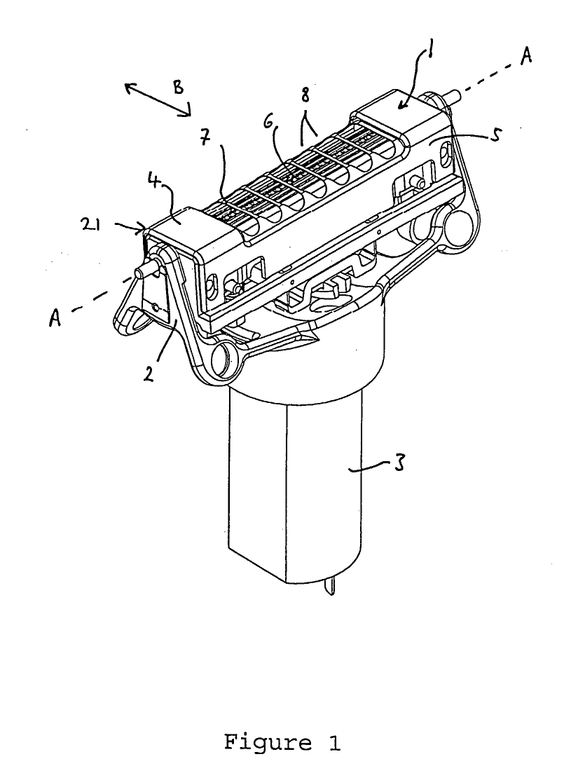

FIG. 1 shows, in perspective view, a first embodiment of a shaving system according to the present invention. As shown, a shaving head 1 is mounted for swivel action about an axis A-A in a yoke component 2. A motor 3 is provided beneath the yoke 2. The shaving head 1 comprises a skin support guard 21. The skin support guard 21 is of generally u-shaped cross-section with an upper skin-engaging surface 4 and two lateral surfaces 5, one of which is visible in FIG. 1. The upper surface 4 has a plurality of windows 8 separated by respective transverse guard bars 7. A blade cartridge 6 is exposed to the skin through these windows 8. The arrow B shows the direction in which the blade cartridge 6 is to be oscillated.

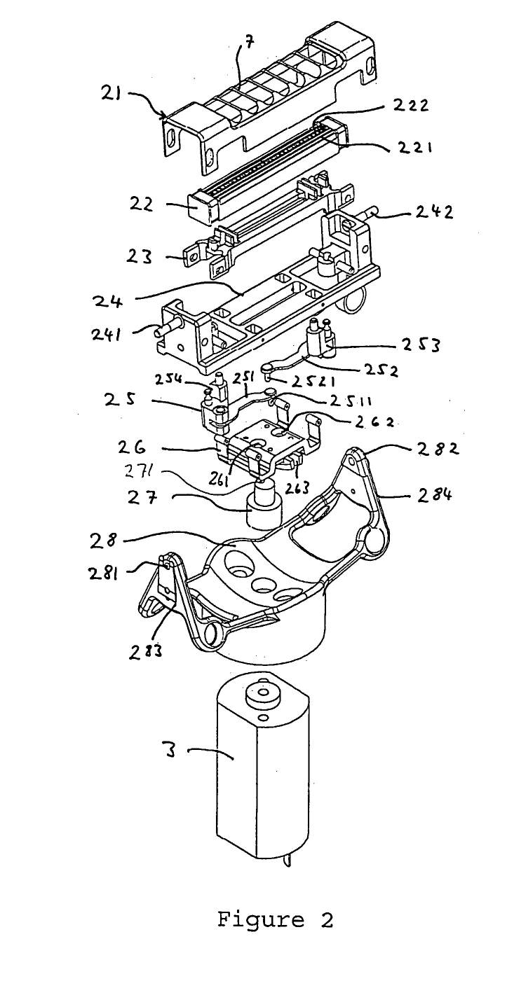

FIG. 2 shows an exploded view of the assembly of FIG. 1. A generally rectangular cartridge 22 carries two pairs of razor sharp blades 221 and 222. The cartridge is carried on a carrier member 23. The carrier 23, cartridge 22 and support guard 21 are all assembled onto a main chassis 24 having swivel bearings 241 and 242. A drive linkage 25 comprises a first linkage member 251 and a second linkage member 252 for converting motion longitudinally of the chassis to transverse motion. Each of the link members 251 and 252 has a respective bearing pin 2511 and 2521 engaging in respective bearing apertures 261 and 262 in a drive bridge 26 mounted beneath the main chassis 24. An arcuate slot 263 is formed on the lower side of the drive bridge 26. Beneath the drive bridge 26 is positioned a cam 27 having a pin 271 which engages in the arcuate slot 263. A u-shaped yoke member 28 receives and supports the head assembly consisting of the skin support guard 21, cartridge 22, cartridge carrier 23, main chassis 24, drive linkage 25 and drive bridge 26. The bearing pins 241 and 242 of the main chassis 24 engage in respective bearing apertures 281 and 282 on the upstanding lateral limbs 283 and 284 of the yoke. The drive motor 3 is coupled to the cam 27 through an aperture in the yoke 28 and thus provides motive power to the cartridge 22 to cause the cartridge to oscillate in directions transverse of the longitudinal axis thereof.

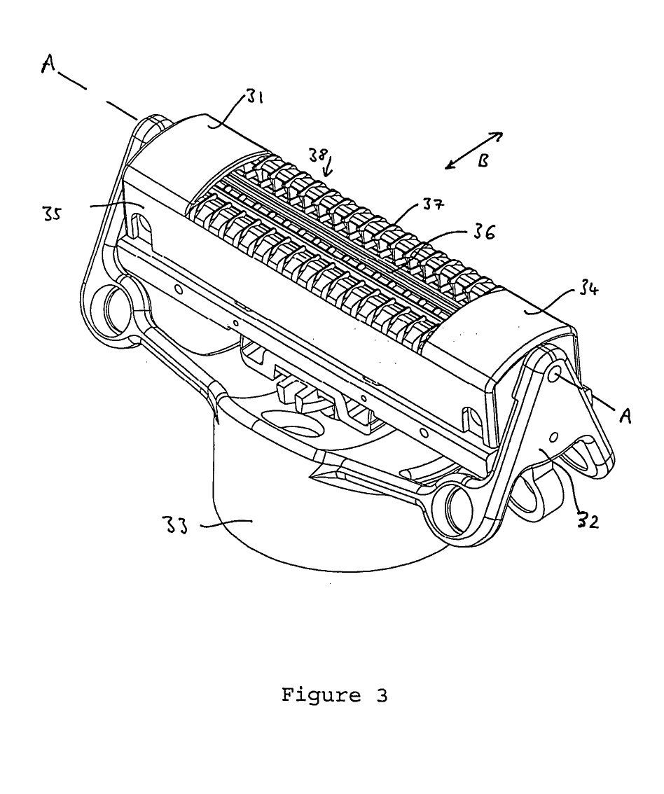

FIG. 3 shows, in perspective view, a second embodiment of a shaving system according to the present invention. As shown, a shaving head 31 is mounted for swivel action about an axis A-A in a yoke component 32. A motor 33 is contained within housing provided beneath the yoke 32. The shaving head 31 has an upper skin-engaging surface 34 and two lateral surfaces 35, one of which is visible in FIG. 3. The upper surface 34 has windows 38 which exposes a blade cartridge 36 and skin stabilising guards 37 wrapped over the cartridge. Arrow B shows the direction of oscillation of the blade cartridge 36.

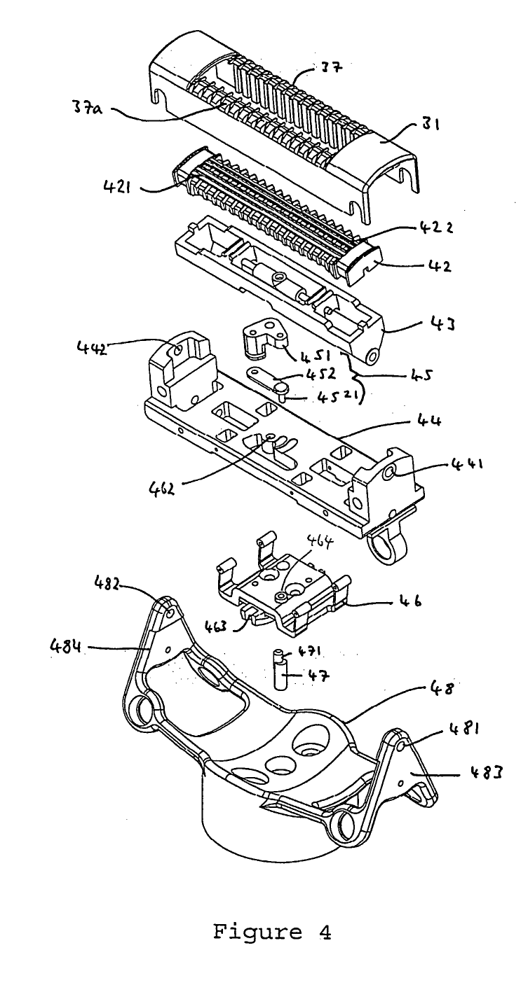

FIG. 4 shows a full-size exploded view of the assembly of FIG. 3. The shaving head 31 comprises two skin support guards 37, 37a. The skin support guards 37, 37a stabilise the skin near the cutting edges. A generally rectangular cartridge 42 carries two pairs of razor sharp blades 421 and 422. The cartridge is carried on a carrier member 43. The carrier 43, cartridge 42 and support guards 37, 37a are all assembled onto a main chassis 44 having swivel bearings 441 and 442. The carrier member 43 is pivotally mounted by its ends in the main chassis 44. A drive linkage 45 comprises a first linkage member 451 and a second linkage member 452 for converting motion longitudinally of the chassis to oscillatory motion of carrier member 43 about an axis parallel to the longitudinal axis of the chassis. The link member 452 has a bearing pin 4521 engaging in a bearing aperture 464 in a drive bridge 46. A pin (not visible) on first linkage member 451 engages in a bearing aperture 462 in the main chassis 44. An arcuate slot 463 is formed on the lower side of the drive bridge 46. Beneath the drive bridge 46 is positioned a cam 47 having a pin 471 which engages in the arcuate slot 463. A u-shaped yoke member 48 receives and supports the head assembly consisting of the skin support guard 31, cartridge 42, cartridge carrier 43, main chassis 44, drive linkage 45 and drive bridge 46. The swivel bearings 441 and 442 of the main chassis 44 engage with respective bearing apertures 481 and 482 on the upstanding lateral limbs 483 and 484 of the yoke 48. The drive motor (not shown) is coupled to the cam 47 through an aperture in the yoke 48 and thus provides motive power to the cartridge 42 to cause the cartridge to oscillate in directions transverse of the longitudinal axis thereof.

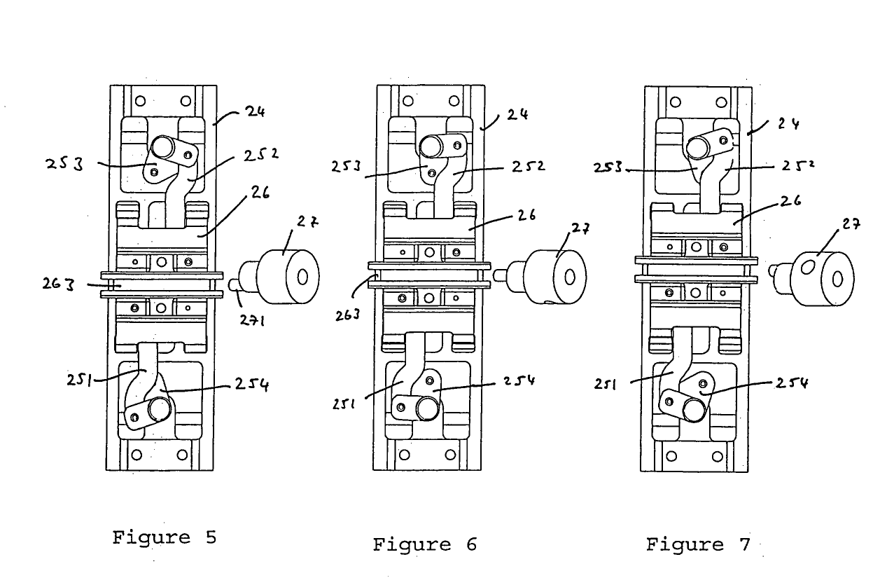

FIGS. 5, 6 and 7 show the shaving head of FIGS. 1 and 2 in its assembled condition and viewed from below. The cam 27 is schematically illustrated. The respective views shown in FIGS. 5, 6 and 7 show the position of the drive mechanism as the cam 27 rotates through 180°, so that the drive pin 271 moves from a lower position in FIG. 5, through an intermediate position in FIG. 6 to an upper position in FIG. 7. The drive pin is engaged in the slot 263 and thus the slot is caused to move progressively upwards as the pin moves from its lower position in FIG. 5 to its upper position in FIG. 7. It will be seen that the upper link member 252 is coupled to a bell crank 253 and similarly the lower drive lever 251 is coupled to a further bell crank lever 254. The swivelling action of the respective bell crank levers 253 and 254 impart transverse motion to the cartridge carrier 23 and thus to the cartridge 22 itself.

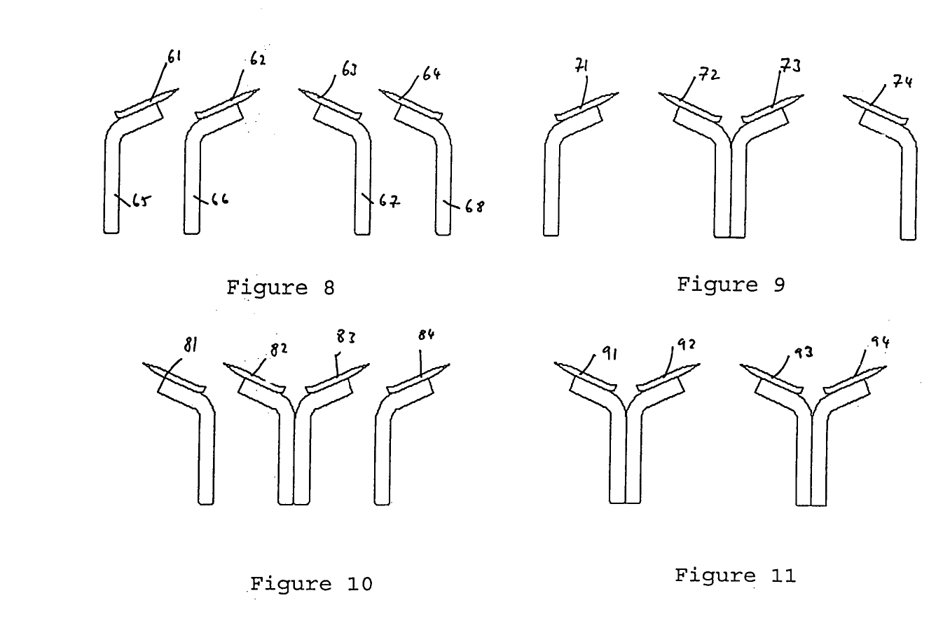

In the preferred embodiment illustrated in FIGS. 1 and 2, the cartridge 22 carries four blades arranged in two pairs. The preferred arrangement of the four blades is shown in FIG. 8. A first pair of blades 61 and 62 is directed to the right and a second pair of blades 63 and 64 is directed to the left in FIG. 8. Each blade 61 to 64 is razor sharp and is mounted on a respective blade carrier 65 to 68. FIGS. 9, 10 and 11 show alternative arrangements of blades. In FIG. 9, the blades 71, 72 of the first pair are arranged to cut in opposed directions, as are the blades 73 and 74 of the second pair. In the embodiment of FIG. 10, the blades 81 and 82 of the first pair are directed towards the left, whereas the blades of the second pair 83 and 84 are directed to the right. Finally, in the embodiment of FIG. 10, the blades 91 and 92 of the first pair point away from each other, as do the blades 93 and 94 of the second pair.

By using two pairs of blades mounted in opposite directions and moving with sufficient stroke and velocity, it is possible to achieve cutting in a direction opposite to that in which the razor is travelling. In other words, cutting “against the grain” is possible whilst traversing the razor in the direction of the grain. With this action, it is possible to cause low lying hairs to be raked up by one pair of blades as they move across the skin and for such hairs then to be cut by the second pair. With this action it is also possible, given the correct velocity, stroke and speed of motion, to achieve hysteresis by means of the second blade engaging the hair before it has had time to retract beneath the skin surface. By allowing the shaving head to pivot, it is possible to shave with up and down strokes without removing the razor from the face.

Although it is preferred to provide two pairs of blades facing in opposite directions as shown in FIGS. 6, 7, 8 and 9, it is also possible within the scope of the invention to provide only one pair of blades facing in opposite directions or facing in the same direction. The hysteresis effect will then not be achieved, but the raking effect described above will still be achievable. Another option would be a pair of blades opposing a single blade.

Using a prototype razor built using a four blade oscillating cartridge of the type shown in FIG. 8, shave tests have been carried out using no lubricant (dry shaving), and with lubricant applied to the face prior to shaving (wet shaving). The wet shaving method gave the best subjective results in respect of comfort and efficiency. The blades were arranged at a pitch of 1.3 mm (spacing between the blades of each pair). Adopting a blade spacing of 1 mm improves the hysteresis effect under appropriate speed and stroke conditions. The narrower blade spacing, with the guard in place, also increases comfort whilst reducing the size of the razor head to allow improved access to difficult areas such as beneath the nose.

Tests with a relatively large blade travel of 2.4 mm, i.e. amplitude 1.2 mm were effective but in the specific configuration used appeared somewhat aggressive. On the other hand, if the stroke is reduced too much, efficiency also reduces. Accordingly, a good compromise is thought to be a stroke in the range of 1.5 to 1.8 mm total travel and frequencies in the region of 250 Hertz. An amplitude of 0.4 mm, i.e. blade stroke 0.8 mm, would represent the lowest practical value which would still shave effectively.

With a standard twin bladed wet razor operating at linear shaving speed of 225 mm per second, the time lapse between engagement of primary and secondary blades in each pair is greater than 5 milliseconds. It has previously been established that hair retracts by about 200 microns in less than 2 milliseconds. The speed of oscillation of the powered blades should be set high enough to dynamically reduce the time lapse between primary and secondary cutting without double engagement or sacrificing washability, i.e. the presence of a clear path for debris removal between the blades.

Where the amplitude of motion is ±1.2 mm and the frequency of oscillation is 100 Hz, this gives an average cutting speed of 480 mm/sec, using a blade spacing of 1.3 mm and thus a calculated hysteresis time of 2.7 ms. This cutting speed gives good cutting results. If it is desired to reduce the hysteresis time to 1.7 ms (i.e. less than 2 ms) this could be achieved with a cutting speed of 600 mm/sec and a blade spacing of 1 mm. This requires an amplitude of ±0.5 mm and a frequency of 300 Hz, for example.

Frequencies in the range 80-300 Hz are preferred, most preferably 120 Hz.

Various methods of achieving the blade motion could be adopted. In the above described embodiments, the motor 3 is mounted in a fixed handle and has an offset cam 27 mounted to it. The cam 27 drives an arcuate cam follower mounted in the swivel head. This arrangement allows the head to follow contours of the face whilst still being driven by the motor. The resultant motion is generally linear along the direction of the blade edges. This motion is converted into drive normal to the blade edges by two L-shaped members 253, 254 (bell cranks) pivoted at their corners. By providing two bell cranks, one at each end of the cartridge, it is ensured that the motion remains parallel. It would also be possible to achieve this motion by the use of an electromagnetic drive mounted within the head itself.

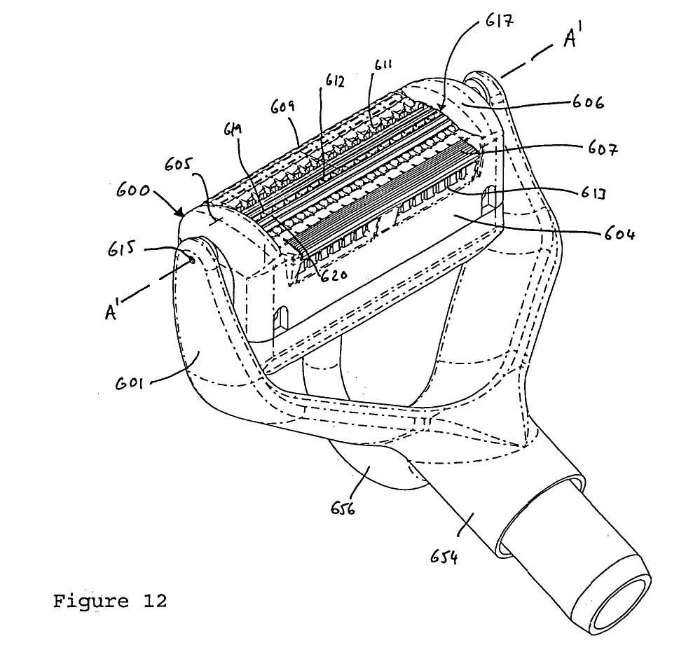

Referring to FIGS. 12 to 15, a third embodiment will now be described. In this embodiment rather than the blade frame cartridge oscillating in a direction parallel to the plane in which the blades lie, it is driven so that it oscillates tangentially to this plane. This tangential or rocking motion has an axis A′-A′ which is parallel to the longitudinal axis defined by the blade edges.

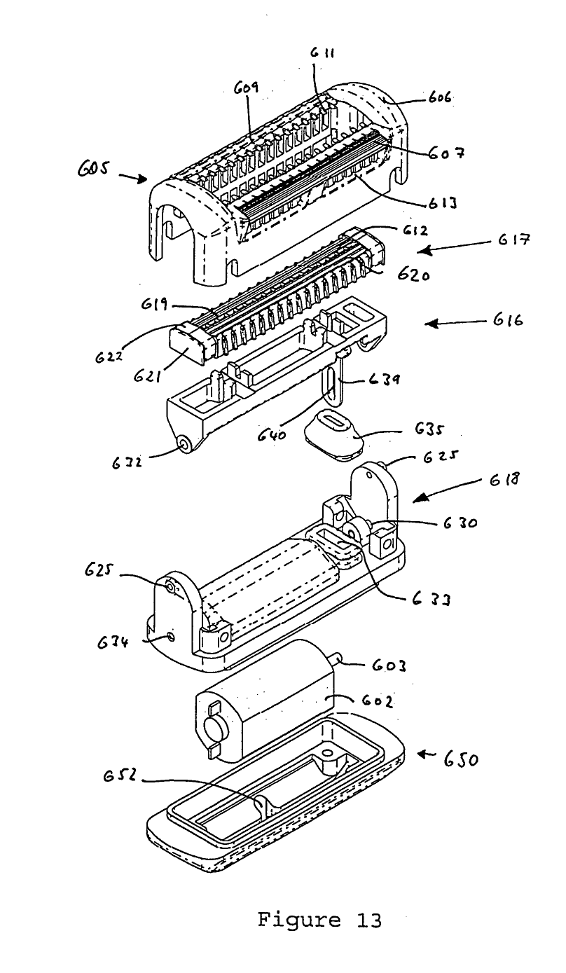

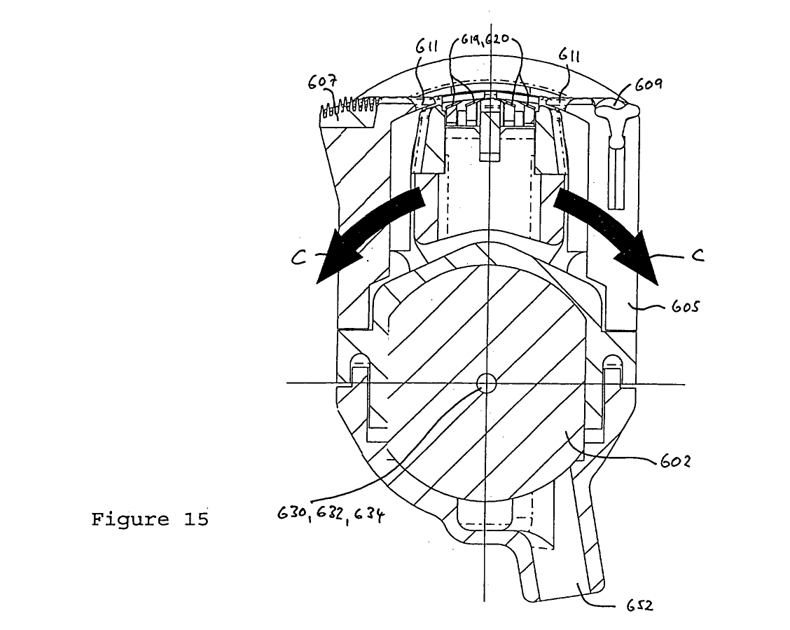

FIG. 12 shows a perspective view and FIG. 13 shows an exploded view of this third embodiment of a shaving system according to the present invention. As shown, a shaving head 600 is mounted for swivel action about an axis A′-A′ in a Y-shaped yoke member 601. The shaving head 600 has a guard frame 605 comprising an upper surface 606 and two lateral surfaces 604, only one of which is visible. A blade cartridge 617, containing blades 619,620, is exposed to the skin through a window in the upper surface 606. The arrows C in FIG. 15 show the direction in which the blade cartridge 617 is to be oscillated.

In the exploded view of FIG. 13 the separate components may be seen. On both of the sides of the window, parallel to the length of the blades 619,620, are skin guard fingers 611. These take the form of a series of projections, projecting towards the centre of the window, and which are designed to support the skin whilst allowing the skin to flow easily over the upper surface of the shaving head, and in particular the cutting area, whilst preventing it from being rubbed or trapped by the non-cutting part of the cartridge. They also help to stabilise the skin near the cutting edges of the blades 619,620.

On one of the sides of the window, parallel with the length of the blades 619,620, a skin engaging support member 607 is located. Skin stretching fins may advantageously be formed on the upper surface of this support member. On the other side of the window from the skin engaging support member 607, a lubricating strip 609 may be located. This aids the lubrication of the skin so that the shaving head may be moved over the skin more rapidly and with comfort and ease.

The cartridge 617 consists of a frame 621 into which the blades 619,620 are placed. These blades are retained by clips 622 around both ends of the frame 621. Further skin support guards 612 are located between the central blades in the form of a series of upward pointing teeth. These skin support guards help to manage the movement of the skin over the shaving head so as to improve the performance of the shaving apparatus and prevent nicks and cuts.

The cartridge 617 is carried on a carrier member 616. This carrier member 616 has bearings 632 located at either end of the carrier. Further, a drive linkage 639 with a drive slot 640 therein projects from the underside of the carrier member 616.

The carrier 616, cartridge 617 and guard frame 605 are all assembled onto a chassis 618. The chassis 618 has yoke bearings 625 and carrier bearings 634. The chassis carrier bearings 634 are associated with the carrier bearings 632 such that the carrier may rock back and forth about an axis through the bearings 632,634. The guard frame 605 and the chassis 618 form an enclosure which remains stationary with respect to the carrier 616 which may oscillate within this enclosure.

The drive linkage 639 has a drive slot 640 and projects through a slot 633 in the chassis 618 and a flexible seal 635 fits around this slot 633 to prevent passage of water.

A chassis base 650 is fixed and sealed to the underside of the chassis 618 forming a water-tight compartment with cable access 652 sealably located in its base. Within this compartment a motor 602 is located. This motor drives an offset drive cam 603.

The drive slot 640 in the drive linkage 639, which projects through the slot 633 in the chassis 618, engages the drive cam 603 within the motor compartment so that when the motor is energised it reciprocately drives the drive linkage 639. This motion is passed to the carrier 616 via the drive linkage 639 such that the carrier 616, the cartridge 617 and the blades 619,620 rock back and forth, about an axis through bearings 632,634, in a direction tangential to the plane comprising the upper surface 606 of the guard frame 605.

The Y-shaped yoke member 601 receives and supports the shaving head assembly 600 comprising of the guard frame 605, cartridge 617, carrier 616, chassis 618, drive linkage 639, chassis base 650 and motor 602. The yoke bearings 615, located on each arm of the yoke, engage the respective chassis yoke member bearings 625 such that the shaving head assembly 600 may freely turn about an axis through the engaged bearings 615,625.

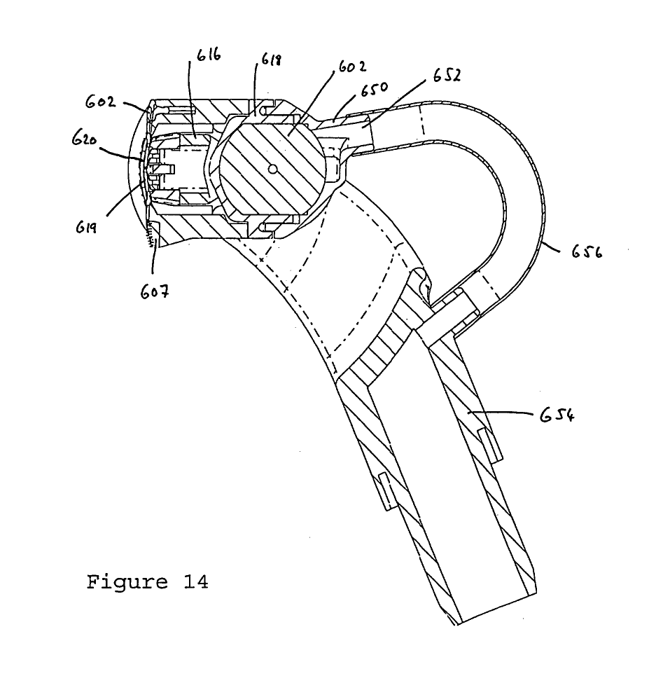

Referring to FIG. 14, the motor 602 is connected to an electrical source via cables which pass through the cable access 652 at the base of the chassis base 650 and through a flexible sealing pipe 656 which extends from the cable access 652 to the handle 654 of the shaving apparatus.

Tests have shown that the optimum characteristics for the action of the shaving apparatus comprise the blades of the cartridge moving through an arc motion equal to a linear distance of ±1.2 mm at a frequency of 120 Hz. However, the range of distance could be from ±0.6 mm to ±2.0 mm and the range of frequencies from 80 to 250 Hz. Further, the inter blade spacing is 0.75 mm between the two middle blades and 1.0 mm between each of the others, if present. Further still, the speed and distance travelled by the blades is similar to that discussed above with regard to the first two embodiments. However, to achieve the “lift and cut” effect, assuming a speed of movement across the face of 250 mm/second, the blades should preferably be moving at an average speed of 600 mm/second.

In all three of the embodiments described above, as well as the different blade arrangements shown in FIGS. 8 to 11, different combinations of blade can also be used in which the first blade in each pair is “blunt” and only used for raking or extending the hairs without cutting.

The use of the skin stabilizing support guard, with its transverse skin-engaging bars, stabilizes the skin and ensures that it remains essentially static whilst being traversed by the vibrating blade arrangements.

Various modifications and alternatives will occur to those skilled in the art. For example, other versions of power drive could be used, for example with regard to the first two embodiments described above a motor mounted in the handle could use a push-pull action on a swivel joint to move the blades. Further, the first two embodiments could have other versions of skin stabilizing guards employed, for example those including lubricating strips and/or fins for stretching the skin, such as described with regard to the third embodiment. Finally, sources of drive other than conventional rotary motors could be employed such as solenoid drives.

Parts List:

| | |
|---|---|
| Shaving head | 1 |
| Yoke component | 2 |
| Motor | 3 |
| Upper surface | 4 |
| Lateral surface | 5 |
| Blade cartridge | 6 |
| Transverse guard bar | 7 |
| Window | 8 |
| Support guard | 21 |
| Cartridge | 22 |
| Carrier member | 23 |
| Chassis | 24 |
| Drive linkage | 25 |
| Drive bridge | 26 |
| Cam | 27 |
| U-shaped yoke member | 28 |
| Shaving head | 31 |
| Yoke component | 32 |
| Motor | 33 |
| Upper skin-engaging surface | 34 |
| Lateral surface | 35 |
| Carrier blade | 36 |
| Skin support guards | 37, 37a |
| Window | 38 |
| Rectangular cartridge | 42 |
| Carrier member | 43 |
| Main chassis | 44 |
| Drive linkage | 45 |
| Drive bridge | 46 |
| Cam | 47 |
| U-shaped yoke member | 48 |
| First blades | 61, 62 |
| Second blades | 63, 64 |
| Blade carrier | 65 to 68 |
| Blades | 71, 72 |
| Blades | 73, 74 |
| Blades | 81, 82 |
| Blades | 83, 84 |
| Blades | 91, 92 |
| Blades | 93, 94 |
| Blades | 221, 222 |
| Bearing pins | 241, 242 |
| First linkage member | 251 |
| Second linkage member | 252 |
| Bell crank | 253 |
| Bell crank lever | 254 |
| Bearing apertures | 261, 262 |
| Arcuate slot | 263 |
| Drive pin | 271 |
| Bearing apertures | 281, 282 |
| Lateral limbs | 283, 284 |
| Blades | 421, 422 |
| Swivel bearings | 441, 442 |
| First linkage member | 451 |
| Second linkage member | 452 |
| Bearing aperture | 462 |
| Arcuate slot | 463 |
| Pin | 471 |
| Bearing apertures | 481, 482 |
| Upstanding lateral limbs | 483, 484 |
| Bearing pins | 2511, 2521 |
| Bearing pin | 4521 |
| Shaving head | 600 |
| Yoke member | 601 |
| Motor | 602 |
| Drive cam | 603 |
| Guard frame | 605 |
| Upper surface | 606 |
| Skin engaging guard member | 607 |
| Lubrastrip [Trademark] | 609 |
| Skin support guards | 611, 612 |
| Drain holes | 613 |
| Yoke bearing | 615 |
| Carrier member | 616 |
| Cartridge | 617 |
| Chassis | 618 |
| Blades | 619, 620 |
| Cartridge frame | 621 |
| Clips | 622 |
| Chassis (yoke) bearing | 625 |
| Pins | 630 |
| Carrier bearing | 632 |
| Chassis slot | 633 |
| Chassis (carrier) bearing | 634 |
| Flexible seal | 635 |
| Drive linkage | 639 |
| Drive slot | 640 |
| Chassis base | 650 |
| Cable access | 652 |
| Handle | 654 |
| Sealing pipe | 656 |

1. A shaving system comprising:
a shaving head structure (24,28; 44,48; 616,618,650);
a blade frame (22; 42; 617) defining a longitudinal axis;
at least two blades (221,222; 421,422; 619,620) mounted in the blade frame, each having a cutting edge extending parallel to the longitudinal axis;
said frame mounted on said structure for oscillatory motion perpendicular to said longitudinal axis; and
a drive system (25,26,27; 45,46,47; 603,640) coupled to said frame to produce said oscillatory motion, wherein the amplitude of said oscillatory motion is at least 0.4 mm and the frequency of said oscillatory motion is at least 80 Hz.

2. A shaving system according to claim 1, wherein said amplitude is in the range 0.4 to 2.0 mm and said frequency is in the range 80 to 300 Hz.

3. A shaving system according to any preceding claim in which at least one blade faces in each of two opposed shaving directions, and the stroke of said oscillatory motion exceeds the spacing between the cutting edges of said oppositely facing blades.

4. A shaving system according to claim 3, wherein said spacing is in the range 0.6 to 1.4 mm and said amplitude is in the range 0.4 to 2.0 mm.

5. A shaving system according to claim 3 or 4 in which a first pair of blades (61,62; 81,82) faces in one direction and a second pair of blades (63,64; 83,84) faces in the other direction.

6. A shaving system according to claim 5 in which the first and second pairs (61,62; 63,64) face each other.

7. A shaving system according to claim 5 in which the first and second pairs face away from each other.

8. A shaving system according to any of claims 1 to 4 in which a pair of blades faces in one direction and a single blade faces in the opposite direction.

9. A shaving system according to any one of the preceding claims, wherein said cutting speed is greater than 400 mm per second.

10. A shaving system according to any one of the preceding claims, in which said blades are all mounted at the same blade angle.

11. A shaving system according to any one of the preceding claims in which said shaving head structure comprises a fixed skin-engaging guard member (21;34;604).

12. A shaving system according to any one of the preceding claims in which said frame is mounted to perform said oscillatory motion in a direction parallel to a plane containing the cutting edges of said blades.

13. A shaving system according to any preceding claim in which said drive system comprises at least one bell crank lever (253,254) mounted on said structure for pivoting action to impart said oscillatory motion to said frame.

14. A shaving system according to claim 11 in which said drive system comprises a pair of bell crank levers mounted on said structure for pivoting action to impart said oscillatory motion to said frame.

15. A shaving system according to any of claims 1 to 11 in which said frame (617) is driven to oscillate about an axis parallel to said longitudinal axis.

16. A shaving system according to claim 15, wherein said cutting speed is greater than 450 mm per second.

17. A shaving system according to claim 15 or 16, in which said drive system comprises an offset drive cam (603) linked to a drive slot (640) mounted on said structure (616, 618, 650) for pivoting action to impart said oscillatory motion to said frame.

18. A method of shaving in which a blade frame carrying at least two spaced blades is caused to perform linear motion over the face and the blade frame is caused to oscillate in the direction of said linear motion with an amplitude of at least 0.4 mm and a frequency of at least 80 Hz.

19. A method according to claim 18 in which said amplitude is in the range 0.4 to 2.0 mm and said frequency is in the range 80 to 300 Hz.

20. A method according to claim 18 or 19 in which the blade frame is caused to oscillate in a rocking motion.

21. A method according to either of claims 18, 19 or 20 in which first and second blades face in opposite directions.

22. A method of shaving according to any of claims 18 to 21 in which the average cutting speed exceeds 400 mm per second.

23. A method according to claim 22 in which the average cutting speed exceeds 450 mm per second.

24. A method according to claims 23 in which the average cutting speed exceeds 600 mm per second.
